(19) United States
(12) Patent Application Publication
(10) Pub. No.: US 2006/0285584 A1
(43) Pub. Date: Dec. 21, 2006

(54) Jitter generator to simulate a closed data eye

(75) Inventors: Steven J. Baumgartner, Zumbro Falls, MN (US); Anthony R. Bonaccio, Shelburne, VT (US); Timothy C. Buchholtz, Rochester, MN (US); Charles P. Geer, Rochester, MN (US); Daniel G. Young, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 11/155,028

(22) Filed: Jun. 16, 2005

(51) Int. Cl. H04L 7/00

(52) U.S. Cl. 375/226

(57) ABSTRACT

Techniques and apparatus for testing jitter tolerance of a device are provided. Jitter control logic within a device may include a master phase rotator to rapidly adjust the phase of a clock signal to simulate jitter in a data stream received by the device. For some embodiments, the rate, magnitude, and signature (or waveform shape) of the phase adjustments may be controlled to simulate high frequency jitter. Errors in received data packets may be monitored while simulating this jitter (e.g., as part of a built in self test) to test the jitter tolerance of a device under test.

### CROSS-REFERENCE TO RELATED APPLICATIONS

This application is related to co-pending U.S. patent application entitled, “Phase Rotator Control Test Scheme” (Atty. Docket No. ROC920040296US1), filed herewith and incorporated by reference in its entirety.

### BACKGROUND OF THE INVENTION

1. Field of the Invention

The present invention generally relates to integrated circuit device testing and, more particularly, to device testing designed to ensure a device under test will tolerate a minimum amount of jitter on a serial communications line.

2. Description of the Related Art

In modern computer systems, data is often exchanged between devices over a high speed serial communications bus with multiple data lines. Each device commonly includes serialization circuitry to serialize parallel data to be sent serially over each data line and de-serialization circuitry to assemble and present in parallel (e.g., to other data processing components on the receiving device) data received serially over a data line.

Clock and data recovery (CDR) circuits are often connected in series with the de-serializer circuits and used to extract (recover) a clock signal from the incoming serial data stream. The general goal of the CDR circuits is to produce (recover) clock signals used to sample incoming data on serial data lines. Ideally, the CDR circuit produces a sampling clock signal with a sampling edge that is aligned with a center of the period in which the serial data is valid between possible transitions.

This period is commonly referred to as the data “eye” due to the corresponding shape in a timing diagram, as illustrated in FIG. 1A. In the ideal timing shown in the eye diagram 100 of FIG. 1A, each data transition is perfectly separated by a single bit unit interval (BUI) 102. The CDR circuit would ideally produce a sampling clock signal aligned with a center point 104 of the data eye, in an effort to ensure the data is sampled when valid and allow for some tolerance. Unfortunately, as illustrated in FIG. 1B, digital communications channels often experience some amount of low or high frequency deviations from ideal timing (labeled as Δt), commonly referred to as jitter. Sufficiently large time deviations can result in data errors, as data from a bit frame that is earlier or later than that intended is sampled.

CDR circuits usually have a requirement for a minimum jitter tolerance. Jitter tolerance for a serial data recovery system generally refers to how much jitter can exist on a serial data pattern while still achieving a specified error rate. Jitter is usually defined in phase modulation spectrums where the lower frequency components are sometimes classified as wander and the higher frequency components as jitter. The higher frequency components are the most difficult jitter components to tolerate since CDR loops usually have a finite tracking bandwidth.

In some cases, it may be desirable to generate jitter, in an attempt to characterize a device tolerance to jitter. The act of generating jitter on a data stream is commonly referred to as “closing the data eye.” It is generally desirable to know exactly how much jitter is being induced on a data stream when running built in self test (BIST) algorithms, so the system is not overstressed resulting in forced failures on components that might work with normally stressed input. Unfortunately, it is difficult to design a built in self test (BIST) algorithm that generates a serial data pattern with a predictable/controllable amount of eye closure since intersymbol interference effects are sensitive to process variations and contribute significantly to the eye closure.

Accordingly, what is needed are improved techniques and apparatus for testing jitter tolerance of a device.

### SUMMARY OF THE INVENTION

The present invention generally provides methods and apparatus for testing jitter tolerance of a device.

One embodiment provides a method of testing jitter tolerance of data processing circuits of an integrated circuit device. The method generally includes generating, on the device, a phase-adjusted clock signal based on a reference clock signal, distributing the phase-adjusted clock signal to the data processing circuits, simulating jitter in a data stream received by the data processing circuits by rapidly adjusting the phase of the phase-adjusted clock signal, and monitoring the data processing circuits for errors while simulating the jitter.

Another embodiment provides an integrated circuit device generally including one or more data processing circuits, each having a phase rotator to adjust a phase of a clock signal received by the data processing circuits and jitter simulation logic. The jitter simulation logic is generally configured to rapidly adjust the phase of the clock signal received by the one or more data processing circuits during a test mode in order to simulate jitter in a data stream received by the data processing circuits.

Another embodiment provides a system generally including a test mechanism and an integrated circuit device coupled to the test mechanism via a multi-bit interface. The integrated circuit device generally includes a plurality of data processing circuits, each configured to receive data over one line of the multi-bit interface and having a phase rotator to adjust a phase of a clock signal to which the data is synchronized, and jitter simulation logic. The jitter simulation logic configured to rapidly adjust the phase of the clock signal received by the one or more data processing circuits during a test mode in order to simulate jitter in a data stream received by the data processing circuits.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIGS. 1A and 1B illustrate exemplary data eye diagrams;

FIG. 2 illustrates an exemplary integrated circuit with jitter simulation logic, in accordance with one embodiment of the present invention;

FIG. 3 illustrates a detailed view of the jitter simulation logic in accordance with one embodiment of the present invention;

FIG. 4 illustrates an exemplary phase rotator;

FIG. 5 is a table of exemplary phasor weights and corresponding phase outputs for the phase rotator of FIG. 4; and

FIG. 6 is a signal timing diagram of the jitter simulation logic of FIG. 3 superimposed with phase rotator test control logic timing.

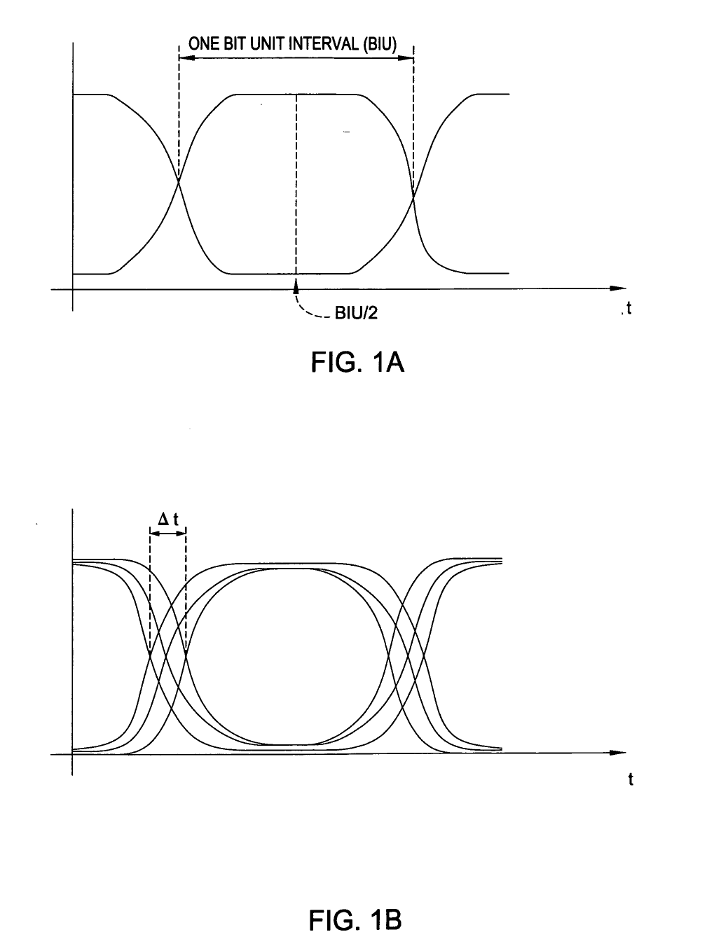

### DETAILED DESCRIPTION OF THE PREFERRED EMBODIMENTS

The present invention generally provides a technique and apparatus for testing jitter tolerance of a device. Jitter control logic within a device may include a master phase rotator to rapidly adjust the phase of a clock signal to simulate jitter in a data stream received by the device. For some embodiments, the rate, magnitude, and signature (or waveform shape) of the phase adjustments may be controlled to simulate high frequency jitter. Errors in received data packets may be monitored while simulating this jitter (e.g., as part of a built in self test) to test the jitter tolerance of a device under test.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### Exemplary Jitter Simulation Logic

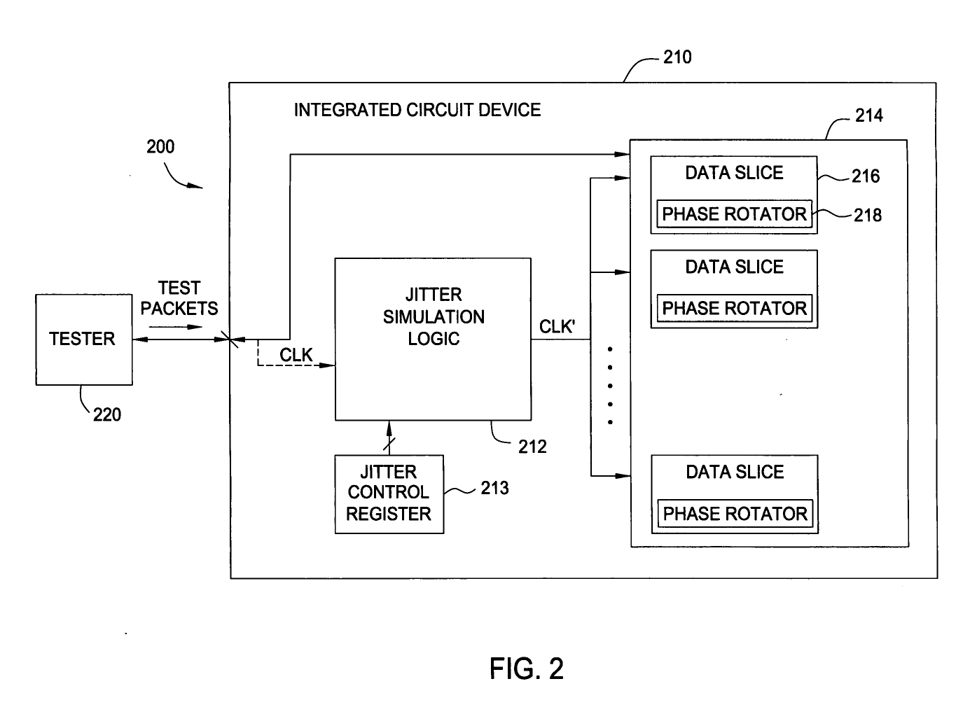

FIG. 2 illustrates an exemplary system 200 for testing the jitter tolerance of an integrated circuit (IC) device 210. As illustrated, the device 210 may include jitter simulation logic 212 configured to vary the phase of a clock signal distributed to a plurality of data processing circuits of a receiver circuit 214 to simulate jitter in accordance with embodiments of the present invention. The IC device 210 may be any type of device utilizing one or more operational phase rotators 218 to adjust the phase of an signal distributed within the device.

For example, the IC device 210 may be a central processing unit (CPU) or a graphics processing unit (GPU). In such cases, the phase rotators 218 may be included as part of de-skew circuitry in a physical layer of a communications interface (e.g., a front-side bus) used to exchange data serially (e.g., with the tester 220). A clock signal may be distributed to different data processing circuits (labeled data slices) 216 that each receive a serial bit of data in conjunction with the clock signal over a different bit line of a multi-bit serial interface. The phase rotator 218 in each data slice 216 may be configured to align the clock signal with the serial data, for example, in an effort to produce a clock signal with a sample edge that is near the center of the data eye of serial data.

In order to test the device for jitter tolerance, for example, during a built in self test (BIST) mode, the jitter simulation logic 212 may be configured to rapidly vary the phase of the clock signal distributed to the data slices 216 to simulate high frequency jitter. By continuing to monitor for errors in data packets received, tolerance of the device 210 to jitter may be determined.

For example, while the logic 212 simulates jitter, the tester 220 may send test or “ping” packets to the device 210. The ping packets may be designed only for testing and thus, may not contain any real data of interest. However, the ping packets may include an appended checksum calculated based on the content of the remainder of the packet. The device 212 may then detect errors by generating its own checksum and comparing the generated checksum to the appended checksum sent with the ping packet. A mismatch indicates an error, which may be due to intolerance of the simulated jitter. In some cases, rather than use an external tester 220 to generate ping packets, a loop-back path may be provided whereby the device itself generates and transmits the ping packets which are fed back to receiver circuit 214.

For some embodiments, the rate, amplitude, and shape or signature of the phase adjustments may be programmable via one or more jitter control registers 213. For example, the jitter control registers may include one or more bits that determine how often (e.g., based on a number of system clock cycles) each phase adjustment or step is made. Another one or more bits may determine a peak-to-peak amplitude of phase adjustments during a jitter cycle. Another one or more bits may specify the signature, such as a saw-tooth pattern (e.g., rapidly incrementing the phase up and down, within the specified peak-to-peak amplitude), a random pattern, or any other type of pattern.

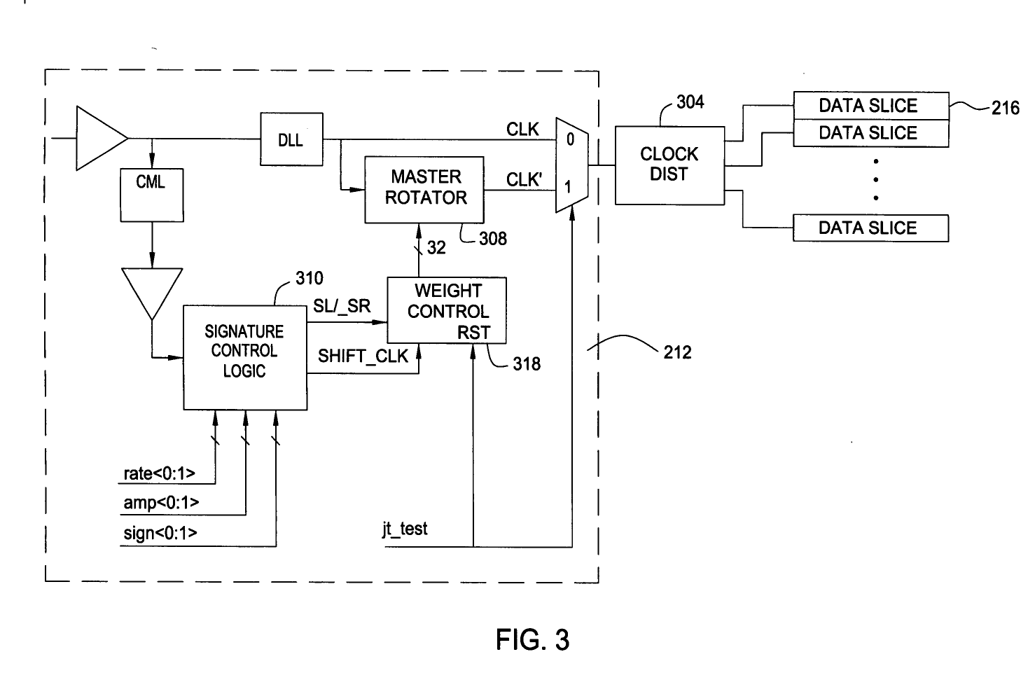

FIG. 3 illustrates exemplary circuitry for implementing the jitter simulation logic 212 according to one embodiment. A master phase rotator 308 may be controlled to rapidly vary the phase of the incoming clock signal during a ping built-in self-test (PBIST) to simulate high frequency jitter. In order to maximize analog tracking and match the phase shifts of the master phase rotator 308 to those of the operational phase rotators 218, the master phase rotator 308 and operational phase rotators 218 may utilize a common design cell.

When performing jitter tolerance testing (e.g., as indicated by a jt_test signal asserted when beginning the testing), the varied clock signal produced by the master phase rotator 308 may be selected by a multiplexor (mux) 302 for distribution by clock distribution logic 304 to the data slices 316. The mux 302 may be controlled by a signal (jt_test) generated when a test mode is enabled such that the varied clock signal is selected when the test mode is enabled and the normal clock signal is selected otherwise.

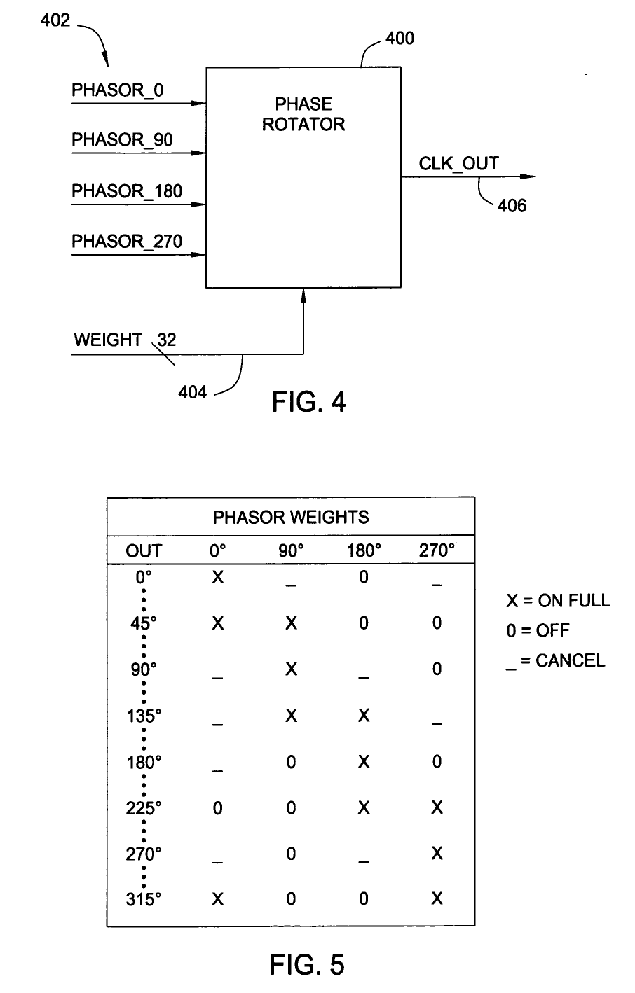

FIG. 4 illustrates an exemplary phase rotator 400 that may be used as the master phase rotator and/or operational phase rotators. The phase rotator 400 generates a clock signal with an adjusted phase by mixing four signals (commonly referred to as phasors) 402 with relative phase offsets of 0 degrees, 90 degrees, 180 degrees, and 270 degrees, in N discrete combinations (by applying different weights to each) to create an output signal with N discrete phases between 0 and 360 degrees. Weights to be applied to each phasor 402 may be specified by a weight code 404 (illustratively, a string of 32 bits).

Fortunately, the magnitude of phase adjustments made to simulate jitter may be very predictable since phase rotators generally have fairly good linearity in their transfer curve where the step size of each step is equal to the 360 degrees divided by the total number of steps N. For example, as illustrated in FIG. 5, which lists exemplary phasor weights and resultant output phases, the output phase of the phase rotator may be adjusted over the entire unit circle (0-360 degrees) in 64 relatively even steps of approximately 6 degrees (360/64), by mixing various weights of either 2 or 3 of the input phasors 102. While the table shows output phases at 45 degree increments, with phasor weights are always either off or on fully, in between these points there is an interpolation applied to create the intermediate phases.

Referring back to FIG. 3, signature control logic 310 may determine the rate, amplitude, and shape of the simulated jitter based on bit signal inputs (e.g., from programmable jitter control registers 213). The signature control logic 310 may be configured to generate control signals to weight control logic 318 to produce weights to the master phase rotator 308 to affect a desired phase change. For example, the signature control logic may generate a clock signal (e.g., labeled shift_clk) that causes a weight generated by the weight control logic 318 to be adjusted. For example, for some embodiments, the weight control logic 318 may maintain a 32 bit register that contains a bit string (of 1's and 0's). Depending on the value of a shift_left/shift_right (SR/_SL) signal, the bit string may be shifted left or right with each rising/falling edge of the shift_clk signal. The frequency of the shift_clk signal may be determined by one or more rate bits, while the corresponding values of the SR/_SL signal may be varied to generate the pattern selected specified by one or more signature bits.

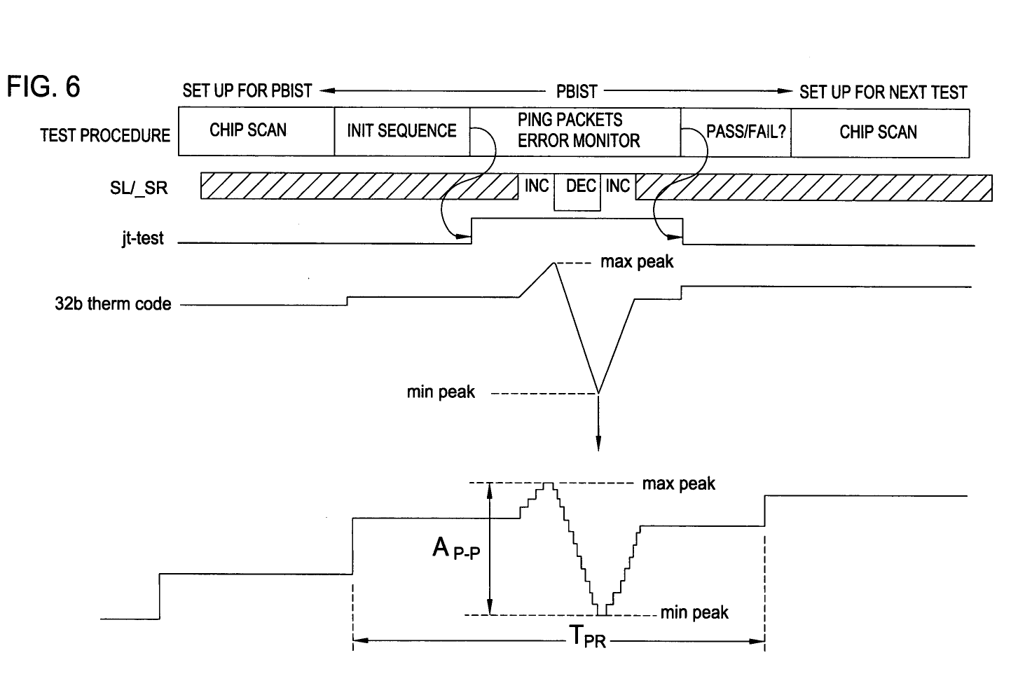

As an example, to vary the output phase to generate the saw-tooth shaped jitter pattern illustrated in FIG. 6, the signature control logic 310 may assert the SR/_SL signal to adjust the phase in multiple steps (e.g., by shifting the weight string right), triggered by the clock signal, until the max peak phase (e.g., as specified by amplitude bits) has been reached. The signature control logic 310 may then de-assert the SR/_SL signal to decrement the phase in multiple steps until the minimum peak phase is reached (e.g., by shifting the weight string left). The weight control clock signals may be generated by dividing the system clock signal by a clock divisor selected based on the rate bits (e.g., to generate a weight control signal every 4, 16, 64, etc. system clock signals).

As illustrated in FIG. 6, jitter testing may begin with an Init Sequence, for example, to initialize the master phase rotator 308 to produce a know phase output (e.g., 0 degrees). After the initialization sequence, the jt_test signal may be asserted, to select the phase adjusted clock signal with the mux 302. As the phase of the clock signal is adjusted to simulate jitter as described above, ping packets (e.g., sent from tester 320 or looped-back) may be monitored for errors.

### Jitter Simulation Combined with Phase Rotater Testing

As described in co-pending U.S. patent application entitled, “Phase Rotator Control Test Scheme” (Atty. Docket No. ROC920040296), filed herewith and incorporated by reference in its entirety, a master phase rotator may also be used to sweep the phase of an adjusted-phase clock over an entire range to test for defects in operational phase rotators 218. For some embodiments, the jitter simulation described herein may be combined with such phase rotator testing.

For example, the relatively rapid phase adjustments described herein to simulate high frequency jitter may be superimposed on relatively slow phase adjustments made while sweeping an entire range to test phase rotators. As an example, during phase rotator testing, phase adjustments may be made every 512 clock cycles or less often. In contrast, during jitter simulation, phase adjustments may be made more rapidly (e.g., every 4 clock cycles or more often).

Therefore, a BIST algorithm that combines phase rotator and jitter testing may be provided that adjusts the phase of a clock signal distributed to operational phase rotators by superimposing rapid phase adjustments along with relatively slow phase adjustments. If only phase rotator testing were to be performed, each phase step may be maintained for a relatively long period to allow the operational phase rotators to adjust. However, to incorporate jitter testing, the phase may be adjusted rapidly within this relatively long period to simulate jitter, while returning to the initial adjusted phase. After the relatively long period has expired, the phase may again be adjusted, as per phase rotator testing, and rapid phase adjustments may again be made to simulate jitter. These operations may be repeated as the phase of the output clock is adjusted over the entire range (e.g., an entire 360 degree rotation).

### CONCLUSION

By rapidly adjusting the phase of a clock signal distributed to one or more data processing circuits, jitter in the data stream may be simulated. By utilizing phase rotators, the jitter amplitude may be uniformly controlled. As a result, a BIST algorithm may be implemented that helps determine jitter tolerance of a device.

While the foregoing is directed to embodiments of the present invention, other and further embodiments of the invention may be devised without departing from the basic scope thereof, and the scope thereof is determined by the claims that follow.

What is claimed is:

1. A method of testing jitter tolerance of data processing circuits of an integrated circuit device, comprising:
generating, on the device, a phase-adjusted clock signal based on a reference clock signal;
distributing the phase-adjusted clock signal to the data processing circuits;
simulating jitter in a data stream received by the data processing circuits by rapidly adjusting the phase of the phase-adjusted clock signal; and
monitoring the data processing circuits for errors while simulating the jitter.

2. The method of claim 1, wherein distributing the phase-adjusted clock signal to the phase rotator circuit of the data processing circuit, comprises:
generating a test signal when entering a test mode; and
controlling a multiplexor with the test signal to distribute the phase-adjusted clock signal to the phase rotator circuit of the data processing circuit.

3. The method of claim 1, wherein monitoring the data processing circuit for errors comprises monitoring known packets of data, at least a portion of which is received by the data processing circuit.

4. The method of claim 1, wherein generating the phase-adjusted clock signal comprises generating the phase-adjusted clock signal with a master phase rotator.

5. The method of claim 4, wherein generating the phase-adjusted clock signal with the master phase rotator comprises varying a multi-bit weight code provided to the master phase rotator.

6. The method of claim 1, wherein an overall peak-to-peak amplitude of phase adjustments during the jitter simulation is programmable.

7. The method of claim 1, wherein a rate of phase adjustments during the jitter simulation is programmable.

8. The method of claim 1, wherein a pattern of phase adjustments during the jitter-simulation is programmable.

9. An integrated circuit device, comprising:
one or more data processing circuits, each having a phase rotator to adjust a phase of a clock signal received by the data processing circuits; and
jitter simulation logic configured to rapidly adjust the phase of the clock signal received by the one or more data processing circuits during a test mode in order to simulate jitter in a data stream received by the data processing circuits.

10. The device of claim 9, wherein the one or more data processing circuits comprise a plurality of data processing circuits to receive data serially in conjunction with the received clock signal over a multi-bit interface.

11. The device of claim 9, wherein the jitter simulation logic comprises a multiplexor configured to distribute the phase-adjusted clock signal to the phase rotator circuit of the data processing circuit when a test signal indicates the device is in a test mode.

12. The device of claim 11, wherein the multiplexor distributes a clock signal, on which the phase-adjusted clock signal is based, to the data processing circuits when the test signal indicates the device is not in the test mode.

13. The device of claim 9, wherein the jitter simulation logic comprises a master phase rotator that adjusts the phase of the received clock signal distributed to the data processing circuits based on weight code.

14. The device of claim 13, wherein the jitter simulation logic comprises weight control logic configured to adjust the weight code based on a clock signal on which the phase-adjusted clock signal is based.

15. The device of claim 13, wherein the jitter simulation logic comprises clock divisor circuitry configured to generate a shift clock signal to cause the weight control logic to adjust the weight code.

16. The device of claim 15, wherein:
the device further comprises one or more jitter control registers; and
at least one of a rate, peak-to-peak amplitude, and overall pattern of phase adjustments during jitter simulation is programmable via one or more bits of the one or more jitter control registers.

17. A system, comprising:
a test mechanism; and
an integrated circuit device coupled to the test mechanism via a multi-bit interface, the integrated circuit device comprising:
a plurality of data processing circuits, each configured to receive data over one line of the multi-bit interface and having a phase rotator to adjust a phase of a clock signal to which the data is synchronized, and
jitter simulation logic configured to rapidly adjust the phase of the clock signal received by the one or more data processing circuits during a test mode in order to simulate jitter in a data stream received by the data processing circuits.

18. The system of claim 17, wherein the integrated circuit device is a central processing unit.

19. The system of claim 17, wherein the integrated circuit is configured to detect defects in the phase rotators of the data processing circuits by monitoring ping packets received while the phase rotator test logic adjusts the phase of the clock signal received by the data processing circuits.

20. The system of claim 17, wherein the test mechanism comprises a feedback loop that routes ping packets generated by transmit circuitry at the device back to the receive circuitry including the data processing circuits.
